(19) United States
(12) Patent Application Publication
(10) Pub. No.: US 2017/0169008 A1
(43) Pub. Date: Jun. 15, 2017

(54) METHOD AND ELECTRONIC DEVICE FOR SENTIMENT CLASSIFICATION

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Chaoming KANG, Beijing (CN)

(21) Appl. No.: 15/241,994

(22) Filed: Aug. 19, 2016

Related U.S. Application Data
(63) Continuation of application No. PCT/CN2016/088671, filed on Jul. 5, 2016.

(30) Foreign Application Priority Data
Dec. 15, 2015 (CN) 201510938180.2

(51) Int. Cl. G06F 17/27

(52) U.S. Cl. CPC G06F 17/2785; G06F 17/274; G06F 17/2735; G06F 17/2765

(57) ABSTRACT

Embodiments of the present disclosure provide a method and device for emotion classification method. The method comprises: obtaining a plurality of keywords in a document to be processed; looking up at least one associated word associated with each of the keywords according to a preset association mode; determining emotion category of each of the keywords and the associated words using a preset emotion dictionary; counting the number of words corresponding to each of the emotion categories; and determining the emotion category with the largest number of words as the emotion category of the document to be processed.

### CROSS REFERENCE TO RELATED APPLICATION

This application is a continuation of International PCT Patent Application No. PCT/CN2016/088671, filed Jul. 5, 2016 (attached hereto as an Appendix), and claims benefit/priority of Chinese patent application No. 201510938180.2, filed with the State Intellectual Property Office of China on Dec. 15, 2015, which are all incorporated herein by reference in entirety.

### TECHNICAL FIELD

The present disclosure relates to a computer technology field, and in particular, to a method and device for emotion classification.

### BACKGROUND

With the development of internet technology, there will be a large amount of news comments with various emotional colors or emotional tendencies of users on the internet after a film is released, which not only provides merchants with a platform showing public opinion on film but also provides consumers with viewing basis of film.

Currently, the merchants and consumers generally search and browse the information regarding films on the internet manually, and have to manually filter out useless messages during the searching process, which has a low screening efficiency and slow speed. This will waste a lot of time and energy of the consumers and merchants.

### SUMMARY

The present disclosure provides a method and electronic device for emotion classification so as to overcome problems existing in related technologies.

According to a first aspect of an embodiment of the present disclosure, a method for emotion classification is provided, including: obtaining a plurality of keywords in a document to be processed; looking up at least one associated word associated with each of the keywords according to a preset association mode; determining emotion category of each of the keywords and the associated words using a preset emotion dictionary; counting the number of words corresponding to each of the emotion categories; and determining the emotion category with the largest number of words as the emotion category of the document to be processed.

According to a second aspect of an embodiment of the present disclosure, a non-volatile computer storage medium stored with computer executable instructions is provided, wherein the computer executable instructions are set to perform any one of the above methods for emotion classification of the present disclosure.

According to a third aspect of an embodiment of the present disclosure, an electronic device is provided, which includes one or more processors and a memory storing instructions executable by the one or more processors, wherein the instructions are set to perform any one of the above methods for emotion classification of the present disclosure.

It should be understood that the above general description and following detailed description are only exemplary and explanatory without limiting the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for emotion classification according to some exemplary embodiments of the present disclosure;

FIG. 2 is a flow chart of step S102 in FIG. 1 in the present disclosure;

FIG. 3 is another flow chart of a method for emotion classification according to some exemplary embodiments of the present disclosure;

FIG. 4 is a flow chart of step S101 in FIG. 1 in the present disclosure;

FIG. 5 is a structural diagram of a device for emotion classification according to some exemplary embodiments of the present disclosure; and

FIG. 6 is a hardware structure diagram of an electronic device for performing a method for emotion classification according to some embodiments of the present disclosure.

### DETAILED DESCRIPTION

Exemplary embodiments will be described in details herein, examples of which are shown in drawings. When the following description is related to accompanying drawings, same reference numerals in different drawings refer to same or similar elements unless otherwise noted. Implementations described in the following exemplary embodiments do not represent all implementations according to the present disclosure. In contrast, they are only examples of device and method described in details in the attached claims and according to some aspects of the present disclosure.

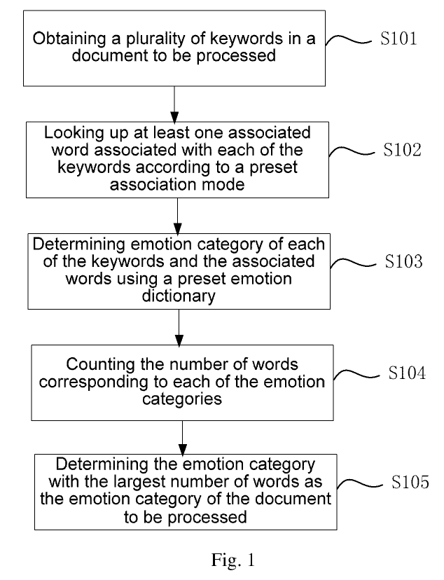

In order to perform emotion classification on a document according to an emotion subject of the document, a method for emotion classification is provided in some embodiments of the present disclosure as shown in FIG. 1, which includes the following steps.

In step S101, a plurality of keywords in a document to be processed are obtained.

In practical applications, the higher the frequency that a word occurs in a text is, the more important this word to this text is, wherein the frequency is calculated by Term Frequency (TF). However, for the whole of all texts, the higher the frequency that a word occurs, the more indiscriminative and unimportant this word to the whole of all texts is. Therefore, it needs a weight coefficient for judging significance of a word. In the case that a word is uncommon but occurs in a text frequently, the word exhibits may the property of this text in some degree, that is, it can be used as a keyword. The Inverse Document Frequency (IDF) may be used as a weight coefficient, and TF-IDF value of a word is obtained by multiplying values of TF and IDF. The larger the TF-IDF value of a word is, the more important this word to an article is. In some embodiments of the present disclosure, for all news of a film, a keyword set K is established by calculating the TF-IDF values of all words and setting a threshold value.

In the step, a plurality of keywords may be obtained by extracting a plurality of words having the highest occurring frequency in the document to be processed, or a plurality of most important keywords may be extracted from the document to be processed, or a plurality of keywords may be obtained through input by a user.

In step S102, at least one associated word associated with each of the keywords is looked up according to a preset association mode.

In some embodiments of the present disclosure, the preset association mode may refer to Apriori association rule algorithm, the associated word may refer to a word associated to a keyword, and the “associated” refers to that support degree and confidence degree are greater than or equal to certain minimum support threshold and minimum confidence threshold.

In the step, at least one associated word to a keyword may looked up in the document to be processed by Apriori association rule algorithm.

In step S103, emotion category of each of the keywords and the associated words is determined using a preset emotion dictionary.

In some embodiments of the present disclosure, words in the preset emotion dictionary may be classified into three emotion categories: positive emotion category, medium emotion category and negative emotion category, for example, words such as ‘like’, ‘good’, ‘excellent’, ‘classic’ and ‘fond of’ may be of positive emotion category, words such as ‘general’ and ‘so-so’ may be of medium emotion category, and words such as ‘boring’, ‘poor’ and ‘tedious’ may be of negative emotion category.

In the step, each of the keywords and associated words are compared to words in the preset emotion dictionary, and if a current keyword or associated word is identical to a word in the preset emotion dictionary, the emotion category of the current keyword or associated word may be determined as the emotion category to which the word in the preset emotion dictionary belong.

In step S104, the number of words corresponding to each of the emotion categories is counted.

In the step, one emotion variable is provided for each emotion category, for example, countP, countM and countN. If a keyword or associated word identical to the word in the preset emotion dictionary is detected, the emotion variable is incremented by 1 according to the emotion category to which the current keyword or associated word belongs.

In step S105, the emotion category with the largest number of words is determined as the emotion category of the document to be processed.

In the step, by comparing the emotion variables corresponding to the emotion categories, the emotion category having a maximum emotion variable may be determined as the emotion category of the document to be processed.

According to the method provided by the embodiment of the present disclosure, a keyword set of an emotion theme is obtained through extracting keywords of a document; noise unrelated to the emotion theme of the document to be processed is ignored by effectively using information of the emotion theme of the document; a set of associated words associated with keywords in the document is formed through an algorithm of association rule; and semantic relations between words in the document are utilized, thus accuracy of document emotion classification is effectively improved.

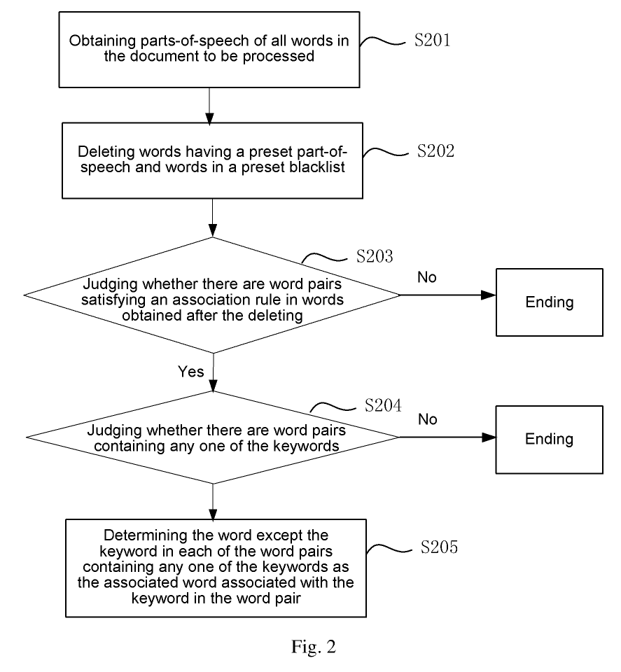

As shown in FIG. 2, in another embodiment of the present disclosure, step S102 includes the following steps.

In step S201, parts-of-speech of all words in the document to be processed are obtained.

In some embodiments of the disclosure, the part-of-speech may refer to noun, verb, adjective, numeral, quantifier, pronoun, adverb, preposition, conjunction, auxiliary, interjection, onomatopoeia and the like.

In the step, the document to be processed may be segmented according to punctuations to generate a set containing n sentences S={s1, s2, . . . , sn}, each sentence si (1≦i≦n) is subjected to word segmentation, and the part-of-speech of each word is marked, thereby obtaining the parts-of-speech of all words.

In step S202, words having a preset part-of-speech and words in a preset blacklist are deleted.

In some embodiments of the present disclosure, the preset part-of-speech may refer to interjection, preposition, onomatopoeia, quantifier and the like, and the preset blacklist may refer to preset words irrelevant to the emotion classification of the document.

In the step, the words having the preset parts-of-speech and the words identical to the words in the preset blacklist are deleted, to generate a set W containing n words, W={w1, w2, . . . , wn}.

In step S203, it is judged whether there are word pairs satisfying an association rule in words obtained after the deleting.

For each element wi (1≦i≦n) in W, the support degree and confidence degree of a word pair made up of any two words (word A, word B) are calculated respectively. the support degree is calculated, i.e. a joint probability of words A and B is calculated, with the following equation:

P(A, B)=count(A ∩ B)/(count(A)+count(B))

Wherein, count(A ∩ B) represents a frequency that A and B occurs at the same time, count(A) represents a frequency that A occurs, count(B) represents a frequency that B occurs. The confidence degree (i.e. the probability that B occurs in the case where A occurs) is calculated by using the word pairs having the support degree P(A, B) greater than or equal to a preset minimum support degree threshold (A, B) as a frequent item set, with the following equation:

P(B|A)=P(A, B)/P(A)

Wherein, P(A, B) refers to the support degree calculated by the previous step, and P(A) refers to a probability that A occurs. An associated item set is obtained, and in the frequent item set obtained previously, word pairs (word A, word B) having the confidence degree P(B|A) larger than preset minimum confidence threshold are added into an associated item set C.

In step 204, it is judged whether there are word pairs containing any one of the keywords, when there are the word pairs satisfying the association rule.

In this step, the associated item set C may be filtered to judge whether two words in each word pair in the set C include elements in keywords set K extracted previously. If not, the word pair will be deleted from the set C, and the remained elements in the set C form a set D.

In step S205, the word except the keyword in each of the word pairs containing any one of the keywords is determined as the associated word associated with the keyword in the word pair, when there are the word pairs containing any one of the keywords.

In the method provided according to the embodiment of the present disclosure, associated words associated with keywords may be looked up automatically by using an association rule, which is simple and highly efficient with less calculation.

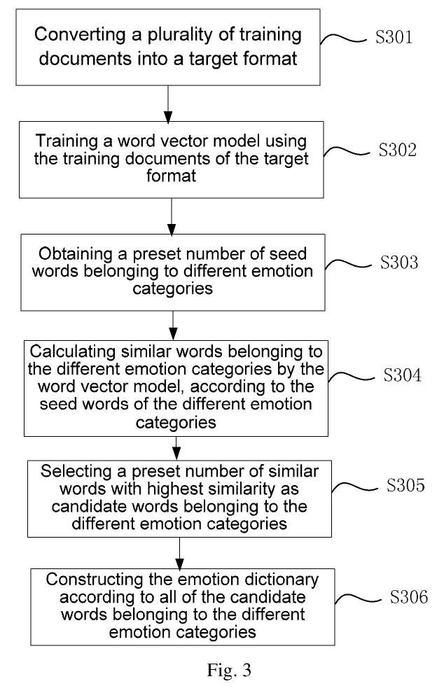

In still another embodiment of the present disclosure, as shown in FIG. 3, the method further includes the following steps.

In step S301, a plurality of training documents are converted into a target format.

In this step, a large number of texts collected from network may be used as training texts, and the training texts are processed into an input format required by word2vec. Word2vec is a tool for characterizing words as real value vectors, which uses the idea of deep learning to map each word into a K-dimensional real value vector (K generally refers to super parameter in a model) for judging semantic similarity between words through distance therebetween (such as cosine similarity, Euclidean distance etc.).

In step S302, a word vector model is trained using the training documents of the target format.

In step S303, a preset number of seed words belonging to different emotion categories are obtained.

Several emotion words may be collected as seed words through a manual way etc. before this step.

In step S304, similar words belonging to the different emotion categories are calculated by the word vector model, according to the seed words of the different emotion categories.

In step S305, a preset number of similar words with highest similarity are selected as candidate words belonging to the different emotion categories.

For example, the former 5 similar words with the highest similarity may be selected as candidate words, the 5 candidate words are taken as seed words, steps S304 and S305 are repeated (which may be performed for 3 iterations), and then a certain number of similar words, such as 15 words, under each emotion category after the iteration are selected as candidate words for the emotion category.

In step S306, the emotion dictionary is constructed according to all of the candidate words belonging to the different emotion categories.

In this step, all of the candidate words under an emotion category may be constructed into corresponding sub-emotion dictionaries respectively, such as a positive dictionary P, a neutral dictionary M, and a negative dictionary N, etc., and these sub-emotion dictionaries constitute an emotion dictionary.

In the method provided according to the embodiment of the present disclosure, a large number of training texts may be used as training materials to continuously generate similar words according to seed words, and the similar words with the highest similarity are selected as candidate words to construct an emotion dictionary. The constructed emotion dictionary may be used more widely, and is more suited to be taken as basis for emotion classification under large database conditions.

In still another embodiment of the present disclosure, the step S101 includes the following steps.

In step S401, keywords with importance degrees greater than a preset importance degree in the document to be processed are obtained.

In this step, the importance degree of a word in the document to be processed may be determined by calculating frequency that the word occurs in the document to be processed (that is, term frequency).

Alternatively, in step S402, keywords input by a user are obtained.

In this step, some keywords may be defined by a user. For example, the user wants to see an emotion category of articles related to a specific keyword, such as that the keyword input by the user is director A, then the director A may be used as a keyword for the document to be processed.

The method provided in embodiments of the present disclosure can extract keywords of a document so as to determine emotion categories of the document based on the extracted keywords.

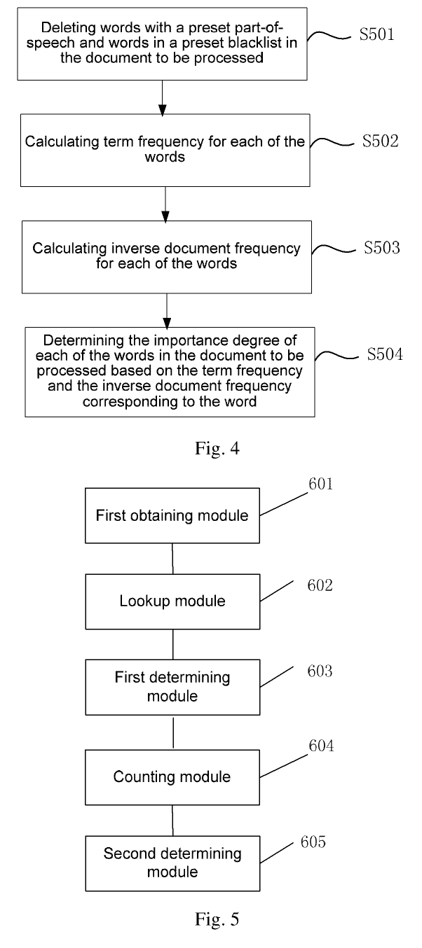

In still another embodiment of the present disclosure, as shown in FIG. 4, the step S401 includes the following steps.

In step S501, words with a preset part-of-speech and words in a preset blacklist in the document to be processed are deleted.

In step S502, term frequency for each of the words is calculated.

In this step, term frequency (TF)=the number that a word occurs in the document to be processed/the number of words in the document to be processed, wherein the term frequency may take an integral part of the quotient. The purpose of dividing by the number of words in a text is for standardization of the term frequency, since lengths of texts are different.

In step S503, inverse document frequency for each of the words is calculated.

Inverse Document Frequency (IDF)=log (total number of texts/(number of texts containing the word+1)), the more common a word is, the larger the denominator is and the smaller the inverse document frequency is and the closer to 0.

In step S504, the importance degree of each of the words in the document to be processed is determined based on the term frequency and the inverse document frequency corresponding to the word.

In this step, TF-IDF=Term Frequency (TF)*Inverse Document Frequency (IDF), wherein a threshold a=0.7 may be set, a word may be added into keyword set K when TF-IDF>a. Each element in the set K may be constituted by the keyword itself and a TF-IDF value of the word<keyword, score>, wherein “keyword” refers to a keyword, and “score” refers to a TF-IDF value.

In the method provided according to the embodiment of the present disclosure, the importance degree of each of the words in the document to be processed may be calculated based on the term frequency and the inverse document frequency, which has less calculation and accurate result.

As shown in FIG. 5, in yet another embodiment of the present disclosure, a device for emotion classification is provided, including a first obtaining module 601, a lookup module 602, a first determining module 603, a counting module 604 and a second determining module 605.

The first obtaining module 601 obtains a plurality of keywords in a document to be processed.

The lookup module 602 looks up at least one associated word associated with each of the keywords according to a preset association mode.

The first determining module 603 determines emotion category of each of the keywords and the associated words using a preset emotion dictionary.

The counting module 604 counts the number of words corresponding to each of the emotion categories.

The second determining module 605 determines the emotion category with the largest number of words as the emotion category of the document to be processed.

In yet another embodiment of the present disclosure, the lookup module includes a first obtaining submodule, a deleting submodule, a first judging submodule, a second judging submodule, and a determining submodule.

The first obtaining submodule obtains parts-of-speech of all words in the document to be processed.

The deleting submodule deletes words having a preset part-of-speech and words in a preset blacklist.

The first judging submodule judges whether there are word pairs satisfying an association rule in words obtained after the deleting.

The second judging submodule judges whether there are word pairs containing any one of the keywords, when there are the word pairs satisfying the association rule.

The determining submodule determines the word except the keyword in each of the word pairs containing any one of the keywords as the associated word associated with the keyword in the word pair, when there are the word pairs containing any one of the keywords.

In yet another embodiment of the present disclosure, the device further includes a converting module, a training module, a second obtaining module, a calculating module, a selecting module and a constructing module.

The converting module converts a plurality of training documents into a target format.

The training module trains a word vector model using the training documents of the target format.

The second obtaining module obtains a preset number of seed words belonging to different emotion categories.

The calculating module calculates similar words belonging to the different emotion categories by the word vector model, according to the seed words of the different emotion categories.

The selecting module selects a preset number of similar words with highest similarity as candidate words belonging to the different emotion categories.

The constructing module constructs the emotion dictionary according to all of the candidate words belonging to the different emotion categories.

In yet another embodiment of the present disclosure, the first obtaining module includes a second obtaining submodule or a third obtaining submodule.

The second obtaining submodule obtains keywords with importance degrees greater than a preset importance degree in the document to be processed.

Alternatively, the third obtaining submodule obtains keywords input by a user.

In yet another embodiment of the present disclosure, the second obtaining submodule includes a deleting module, a first calculating unit, a second calculating unit and a determining unit.

The deleting unit deletes words with a preset part-of-speech and words in a preset blacklist in the document to be processed.

The first calculating unit calculates term frequency for each of the words.

The second calculating unit calculates inverse document frequency for each of the words.

The determining unit determines the importance degree of each of the words in the document to be processed based on the term frequency and the inverse document frequency corresponding to the word.

Some embodiments of the present disclosure provides a non-volatile computer storage medium stored with computer executable instructions, wherein the computer executable instructions may perform the method for emotion classification in any one of the above method embodiments.

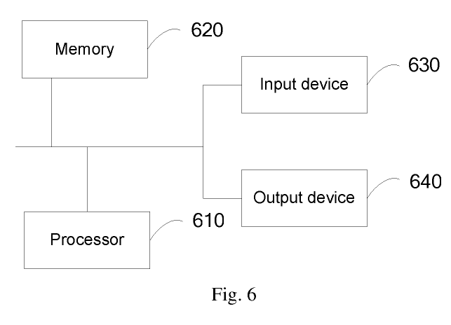

FIG. 6 is a hardware structure diagram of an electronic device for performing a method for emotion classification according to some embodiments of the present disclosure. As shown in FIG. 6, the device includes one or more processors 610 and a memory 620, and FIG. 6 illustrates one processor 610 as an example.

The device for performing a method for emotion classification may further include an input device 630 and an output device 640.

The processor 610, memory 620, input device 630 and output device 640 may be connected with each other through bus or other forms of connections. FIG. 6 illustrates bus connection as an example.

As a non-volatile computer readable storage medium, the memory 620 may be configured to store non-volatile software program, non-volatile computer executable program and modules, such as program instructions/modules corresponding to the method for emotion classification according to the embodiments of the present disclosure (for example, the first obtaining module 601, lookup module 602, first determining module 603, counting module 604 and second determining module 605 as shown in FIG. 5). By executing the non-volatile software program, instructions and modules stored in the memory 620, the processor 610 may perform various functional applications of a server and data processing, that is, the method for emotion classification according to the above method embodiments.

The memory 620 may include a program storage area and a data storage area, the program storage area may be stored with an operating system and applications which are needed by at least one functions, and the data storage area may be stored with data which is created according to use of the device for emotion classification. Further, the memory 620 may include a high-speed random access memory, and may further include a non-volatile memory, such as at least one of disk memory device, flash memory device or other types of non-volatile solid state memory device. In some embodiments, optionally, the memory 620 may include a memory provided remotely from the processor 610, and such memory may be connected with the device for emotion classification through network connections. The examples of the network connections may include but not limited to internet, intranet, LAN (Local Area Network), mobile communication network or combinations thereof.

The input device 630 may receive inputted digital or character information, and generate key signal input related to the user settings and functional control of the device for emotion classification. The output device 640 may include a display device such as a display screen.

The above one or more modules may be stored in the memory 620, and when these modules are executed by the one or more processor 610, the method for emotion classification according to any one of the above method embodiments may be performed.

The above product may perform the methods provided in the embodiments of the present disclosure, and include functional modules corresponding to these methods and advantageous effects. Further technical details which are not described in detail in the present embodiment may refer to the methods provided according to embodiments of the disclosure.

The electronic device in embodiments of the present disclosure may be embodied in various forms, including but not limited to:

(1) mobile communication device, characterized in having a function of mobile communication and mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID and UMPC devices, such as iPad;

(3) portable entertainment device, which can display and play multimedia contents, and includes audio or video player (such as iPod), portable game console , E-book and smart toys and portable vehicle navigation device;

(4) server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned embodiments for the device are merely illustrative, wherein the unit illustrated as a separated component may be or may not be physically separated, the component illustrated as a unit may be or may not be a physical unit, in other words, may be either disposed in a same place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer device (which may be a personal computer, a server, a network device or the like) to perform the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for emotion classification, comprising at an electronic device:
obtaining a plurality of keywords in a document to be processed;
looking up at least one associated word associated with each of the keywords according to a preset association mode;
determining emotion category of each of the keywords and the associated words using a preset emotion dictionary;
counting the number of words corresponding to each of the emotion categories; and
determining the emotion category with the largest number of words as the emotion category of the document to be processed.

2. The method for emotion classification according to claim 1, wherein, the looking up at least one associated word associated with each of the keywords according to the preset association mode comprises:
obtaining parts-of-speech of all words in the document to be processed;
deleting words having a preset part-of-speech and words in a preset blacklist;
judging whether there are word pairs satisfying an association rule in words obtained after the deleting;
judging whether there are word pairs containing any one of the keywords, when there are the word pairs satisfying the association rule; and
determining the word except the keyword in each of the word pairs containing any one of the keywords as the associated word associated with the keyword in the word pair, when there are the word pairs containing any one of the keywords.

3. The method for emotion classification according to claim 1, further comprising:
converting a plurality of training documents into a target format;
training a word vector model using the training documents of the target format;
obtaining a preset number of seed words belonging to different emotion categories;
calculating similar words belonging to the different emotion categories by the word vector model, according to the seed words of the different emotion categories;
selecting a preset number of similar words with highest similarity as candidate words belonging to the different emotion categories; and
constructing the emotion dictionary according to all of the candidate words belonging to the different emotion categories.

4. The method for emotion classification according to claim 1, wherein, the obtaining the plurality of keywords in the document to be processed comprises:
obtaining keywords with importance degrees greater than a preset importance degree in the document to be processed; or obtaining keywords input by a user.

5. The method for emotion classification according to claim 4, wherein, the obtaining keywords with importance degrees greater than the preset importance degree in the document to be processed comprises:
deleting words with a preset part-of-speech and words in a preset blacklist in the document to be processed;
calculating term frequency for each of the words;
calculating inverse document frequency for each of the words; and
determining the importance degree of each of the words in the document to be processed based on the term frequency and the inverse document frequency corresponding to the word.

6. A non-volatile computer-readable storage medium, which is stored with computer executable instructions that, when executed by an electronic device, cause the electronic device to:
obtain a plurality of keywords in a document to be processed;
look up at least one associated word associated with each of the keywords according to a preset association mode;
determine emotion category of each of the keywords and the associated words using a preset emotion dictionary;
count the number of words corresponding to each of the emotion categories; and
determine the emotion category with the largest number of words as the emotion category of the document to be processed.

7. The non-volatile computer-readable storage medium according to claim 6, wherein, the looking up at least one associated word associated with each of the keywords according to the preset association mode comprises:
obtaining parts-of-speech of all words in the document to be processed;
deleting words having a preset part-of-speech and words in a preset blacklist;
judging whether there are word pairs satisfying an association rule in words obtained after the deleting;
judging whether there are word pairs containing any one of the keywords, when there are the word pairs satisfying the association rule; and
determining the word except the keyword in each of the word pairs containing any one of the keywords as the associated word associated with the keyword in the word pair, when there are the word pairs containing any one of the keywords.

8. The non-volatile computer-readable storage medium according to claim 6, wherein, the execution of the computer executable instructions further causes the electronic device to:
convert a plurality of training documents into a target format;
train a word vector model using the training documents of the target format;
obtain a preset number of seed words belonging to different emotion categories;
calculate similar words belonging to the different emotion categories by the word vector model, according to the seed words of the different emotion categories;
select a preset number of similar words with highest similarity as candidate words belonging to the different emotion categories; and
construct the emotion dictionary according to all of the candidate words belonging to the different emotion categories.

9. The non-volatile computer-readable storage medium according to claim 6, wherein, the obtaining the plurality of keywords in the document to be processed comprises:
obtaining keywords with importance degrees greater than a preset importance degree in the document to be processed; or
obtaining keywords input by a user.

10. The non-volatile computer-readable storage medium according to claim 9, wherein, the obtaining keywords with importance degrees greater than the preset importance degree in the document to be processed comprises:
deleting words with a preset part-of-speech and words in a preset blacklist in the document to be processed;
calculating term frequency for each of the words;
calculating inverse document frequency for each of the words; and
determining the importance degree of each of the words in the document to be processed based on the term frequency and the inverse document frequency corresponding to the word.

11. An electronic device, comprising:
at least one processor; and
a memory, communicably connected with the at least one processor and storing instructions executable by the at least one processor,
wherein execution of the instructions by the at least one processor causes the at least one processor to:
obtaining a plurality of keywords in a document to be processed;
looking up at least one associated word associated with each of the keywords according to a preset association mode;
determining emotion category of each of the keywords and the associated words using a preset emotion dictionary;
counting the number of words corresponding to each of the emotion categories; and
determining the emotion category with the largest number of words as the emotion category of the document to be processed.

12. The electronic device according to claim 11, wherein, the looking up at least one associated word associated with each of the keywords according to the preset association mode comprises:
obtaining parts-of-speech of all words in the document to be processed;
deleting words having a preset part-of-speech and words in a preset blacklist;
judging whether there are word pairs satisfying an association rule in words obtained after the deleting;
judging whether there are word pairs containing any one of the keywords, when there are the word pairs satisfying the association rule; and
determining the word except the keyword in each of the word pairs containing any one of the keywords as the associated word associated with the keyword in the word pair, when there are the word pairs containing any one of the keywords.

13. The electronic device according to claim 11, wherein, the execution of the instructions by the at least one processor further causes the at least one processor to::
convert a plurality of training documents into a target format;
train a word vector model using the training documents of the target format;
obtain a preset number of seed words belonging to different emotion categories;
calculate similar words belonging to the different emotion categories by the word vector model, according to the seed words of the different emotion categories;
select a preset number of similar words with highest similarity as candidate words belonging to the different emotion categories; and
construct the emotion dictionary according to all of the candidate words belonging to the different emotion categories.

14. The electronic device according to claim 11, wherein, the obtaining the plurality of keywords in the document to be processed comprises:
obtaining keywords with importance degrees greater than a preset importance degree in the document to be processed; or
obtaining keywords input by a user.

15. The electronic device according to claim 14, wherein, the obtaining keywords with importance degrees greater than the preset importance degree in the document to be processed comprises:
deleting words with a preset part-of-speech and words in a preset blacklist in the document to be processed;
calculating term frequency for each of the words;
calculating inverse document frequency for each of the words; and
determining the importance degree of each of the words in the document to be processed based on the term frequency and the inverse document frequency corresponding to the word.
